(19) United States
(12) Patent Application Publication
(10) Pub. No.: US 2015/0251680 A1
(43) Pub. Date: Sep. 10, 2015

(54) Wheel Contact Protector For A Shoulder-Carriable Wheeled Cart Assembly

(71) Applicant: Robert L. Carter, Naperville, IL (US)

(72) Inventor: Robert L. Carter, Naperville, IL (US)

(21) Appl. No.: 14/639,101

(22) Filed: Mar. 4, 2015

Related U.S. Application Data
(60) Provisional application No. 61/948,538, filed on Mar. 5, 2014.

(51) Int. Cl. B62B 5/00

(52) U.S. Cl. CPC B62B 5/0023; B62B 5/0006

(57) ABSTRACT

A wheel cover is configured to be employed in connection with a backpack-cart. The cover mitigates contact between a user's back and the backpack-cart wheel when the backpack-cart is being employed in backpack mode. The wheel cover can be configured to attach to the backpack-cart's wheel in a variety of ways including an elastic band, a drawstring, a strap with a cooperating hook and loop fastening material, a wheel circumference runner with a cooperating hook and loop fastening material, and a partial clam shell. In some embodiments, a wheel shield can be employed in place of, or in combination with, a wheel cover. The wheel shield can be connected to the backpack-cart and is positioned between the user and the wheels of the backpack-cart when the backpack-cart is being employed in backpack mode. In some embodiments, the wheel shield can also act as a back cushion.

### CROSS-REFERENCE TO RELATED APPLICATION

This application is related to and claims priority benefits from U.S. provisional patent application Ser. No. 61/948,538 having a filing date of Mar. 5, 2014, entitled “Wheel Contact Protector for a Shoulder-Carriable Wheeled Cart Assembly”. The '538 provisional application is hereby incorporated by reference in its entirety.

### FIELD OF THE INVENTION

The present invention relates to wheeled carriers, specifically a backpack-cart, which is a shoulder-carriable extendable handled wheeled cart frame assembly having an extendable front side shelf and shelf support leg. In some embodiments a detachable carrier bag can be attached to the cart frame and positioned over the extendable front side shelf and shelf support leg.

In particular, the invention relates to a backpack-cart having a protective barrier that keeps the external wheel or wheels of the backpack-cart from coming in direct contact with the backpack-cart user when the backpack-cart is being employed in backpack mode.

### BACKGROUND OF THE INVENTION

Throughout time there has been a need for people to find a way to functionally transport heavy and/or bulky items easily without undue stress upon the user's body. Backpacks allow users to carry a pre-determined heavy or bulky article load without undue stress upon their own skeletal structure. In some instances the backpacks can include wheels and function as wheeled carts or dollies allowing the wheels to transfer the weight of the load directly to the ground surface and sparing the user from physically carrying such weight or bulk. Many of these rolling backpacks are of a nature that the bag is not separable from the frame. Shoulder-carriable wheeled cart frame assemblies give the user both options of carrying or wheeling heavy or bulky articles within one device.

There are many devices that include the functional elements of a backpack-cart. Such devices include detachable and adjustable backpack harness straps that the user can wear over their shoulders and carry such devices as a backpack. They also include the ability to place the backpack-cart on the ground and pull the backpack-cart behind the user by an extendable handle. Wheels for backpack-carts have been exhibited as permanently affixed, foldable, or detachably mounted to the cart frame.

Lacking among prior art devices is the ability to prevent, or at least reduce the occurrence of, the wheels from a backpack-cart from coming in contact with the user when the backpack-cart is being employed in its “backpack mode.” “More so, such an improvement would be appreciated, as the wheels of the assembly can get dirty when in contact with the ground. Users would prefer that these dirty wheels not come in contact with them, both for cosmetic and sanitary reasons.

### SUMMARY OF THE INVENTION

The present wheel contact protector for a backpack-cart positions and secures into place a protective moisture resistant membrane barrier between the contact point of a backpack mode wearer of a backpack-cart and the dirty ground contacting external surface area of the backpack-cart's wheel.

One method to position and secure a membrane barrier into place is by creating a wheel cover. In some embodiments, a sock-like protective wheel cover conforms to and secures over the exterior surface of the wheel and covers the point most likely to come in contact with the user. The cover can fit tightly to the wheel so it will not snag or tangle with items it bumps or contacts when the backpack-cart is being employed in backpack mode. A tight fit will also help prevent, or at least reduce the chance of, the cover from falling off and becoming lost. There are many different methods to secure a wheel cover to a backpack-cart's wheel including elastic band closures, drawstring closures, buttons, snaps, zippers, magnets, straps comprising cooperating hook and loop (trade name Velcro) fastening material, wheel circumference runners comprising cooperating hook and loop fastening material, and partial clam shells with wheel interference fit.

Another technique for positioning and securing a membrane barrier into place is by creating a wheel shield. The shield is securely placed between the user and the point of the wheel most likely to come in contact with the user by attaching or affixing it to some portion of the backpack-cart. Among other things, the shield can be the lower harness waist belt of a full pack harness, a cart frame (or axle) attachable snap-on wheel covering shield, or a cart frame attachable back support cushion pad with flared end shields.

### BRIEF DESCRIPTION OF THE DRAWINGS

FIG. 1 is a side elevation view of a backpack-cart in cart mode.

FIG. 2 is a side elevation view of a backpack-cart being employed in backpack mode.

FIG. 3 is a side elevation view of the backpack-cart in FIG. 2 with a wheel cover.

FIG. 4A is a front elevation view of a wheel cover.

FIG. 4B is a side elevation view of a wheel cover.

FIGS. 5A-5E are rear elevation views of different attachment methods for a wheel cover.

FIG. 6 is a side elevation view of a backpack-cart in FIG. 2 with a wheel shield.

FIG. 7 is a front elevation view of a full pack harness outfit including a harness waist belt.

FIG. 8A is a front elevation view of a snap-on wheel shield attached to a frame upright and over a wheel.

FIG. 8B is a side elevation view of the snap-on wheel shield in FIG. 2 attached over the wheel which is attached to frame upright via an axle.

FIG. 9A is the rear elevation view of a backpack-cart in backpack mode with a harness strap attached.

FIG. 9B shows a rear elevation view of a backpack-cart in backpack mode with a back support cushion pad with flared end shields attached to a frame upright.

FIG. 9C is a front elevation view of a back support cushion pad with flared end shields.

### DETAILED DESCRIPTION OF PREFERRED EMBODIMENT(S)

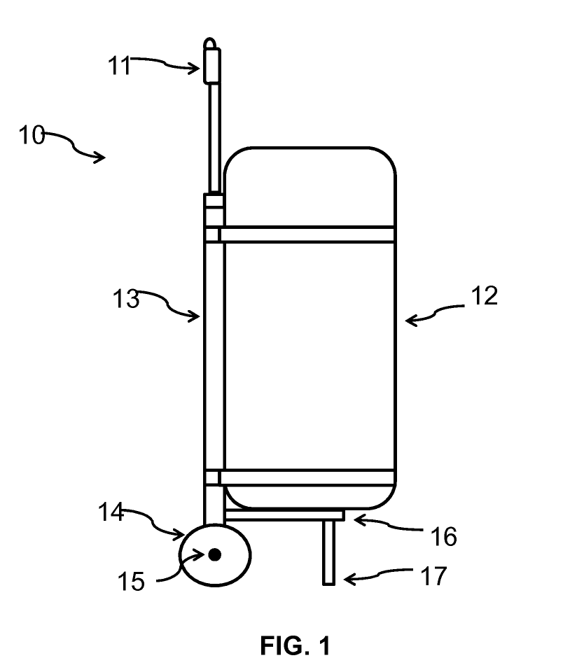

Turning first to FIG. 1, backpack-cart 10 has extendable handle 11. Extendable handle 11 can include a telescoping mechanism such that it can be extended when the backpack-cart is in “cart mode” and contracted when backpack-cart 10 is in “backpack mode”. In some embodiments, extendable handle 11 can be configured to lock at various extensions, allowing for easier use by users of various heights. In other embodiments (not shown) extendable handle 11 folds down.

Also illustrated in FIG. 1 is container bag 12. Container bag 12 is attached to frame upright 13. Container bag 12 is useful to someone using backpack-cart 10 for transporting groceries in an urban setting. In some embodiments, container bag 12 is detachable from the rest of backpack-cart 10. This is especially advantageous when backpack-cart 10 is being employed as a stand-alone dolly to carry containers, boxes or other heavy or bulky items.

FIG. 1 further shows wheel 14 attached to frame upright 13 via axle 15 and front shelf 16 extended and resting on support leg 17. Wheel 14 can be made of a variety of materials including but not limited to rubber, plastic, and metal.

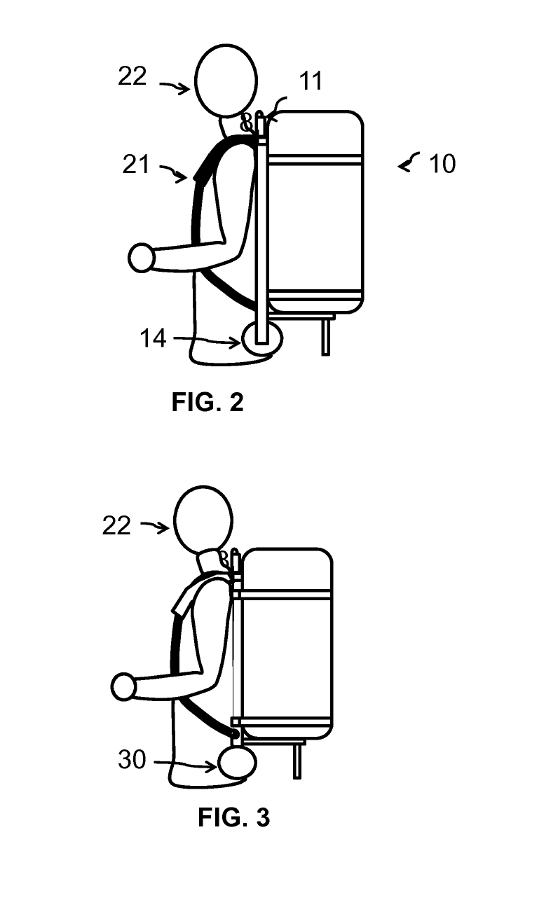

FIG. 2 shows backpack-cart 10 in “backpack mode” with extendable handle 11 in the retracted position. Harness strap 21 is attached to backpack-cart 10 allowing it to be carried by human user 22. FIG. 2 shows the external surface of wheel 14 making direct contact with the posterior of user 22.

FIG. 3 is substantially identical to FIG. 2 with the addition of wheel cover 30 that has been positioned and secured over wheel 14 and provides a protective barrier between the exterior surface of wheel 14 and user 22.

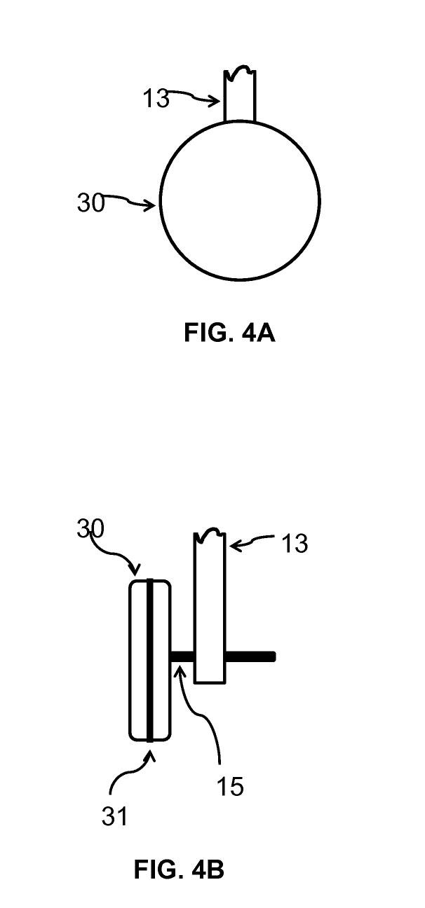

FIG. 4A illustrates wheel cover 30 attached over wheel 14 which is attached to frame upright 13. Similarly FIG. 4B shows a side view of wheel cover 30 attached over wheel 14, which is attached to frame upright 13 via axle 15. In this illustrated embodiment, wheel cover 30 is made up of two halves that are sewn together at wheel cover seam 31.

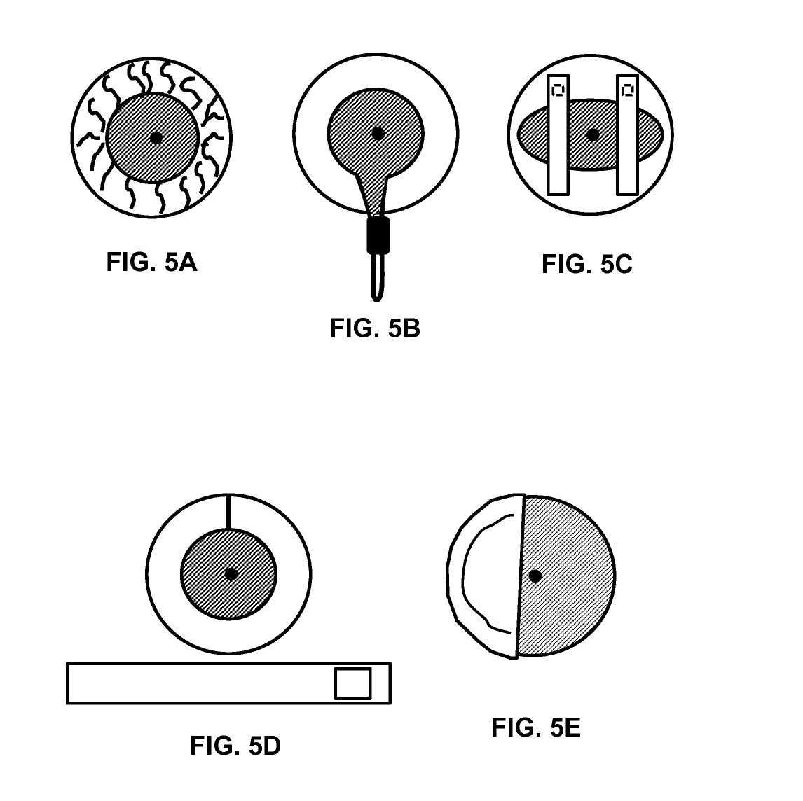

FIGS. 5A, 5B, 5C, 5D, and 5E illustrate different attachment methods for wheel cover 30. FIG. 5A shows an elastic band closure that fits over wheel 14 much like a shower cap. FIG. 5B illustrates wheel cover 30 attached to wheel 14 with a drawstring closure. FIG. 5C illustrates wheel cover 30 attached to wheel 14 with a hook and loop strap closure. FIG. 5D illustrates wheel cover 30 attached to wheel 14 with a hook and loop wheel circumference runner. FIG. 5E illustrates wheel cover 30 attached to wheel 14 with a partial clam shell with a wheel surface contour interference fit. Wheel cover 30 is of such a shape and material that it fits snuggly over wheel 14 and is held in place by tension. In addition to the ways already illustrated, wheel cover 30 can attach to wheel 14 in a variety of ways including, but not limited to: buttons, snaps, magnets, and zippers.

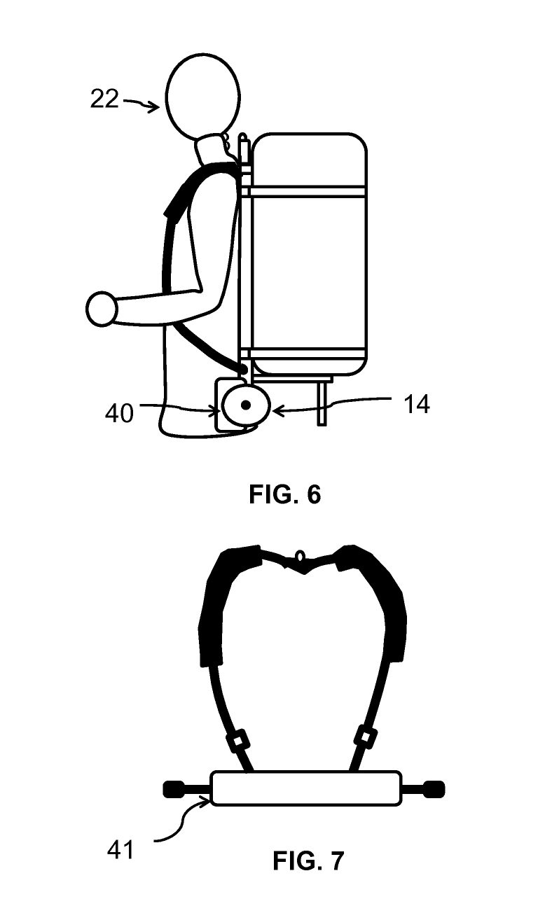

FIG. 6 is identical to FIG. 2 with the addition of wheel shield 40 that is shown positioned and secured to provide a protective barrier between the dirty exterior surface of wheel 14 and user 22. Wheel shield 40 can be made of, among other materials, plastic, fabric, or other moisture resistant materials.

FIG. 7 shows a full pack harness outfit which includes shoulder straps and harness waist belt 41. In some embodiments, the harness waist belt 41 can be widened and positioned such that it is between the contact point of wheel 14 and user 22. Harness waist belt 41 can also be padded to provide further comfort.

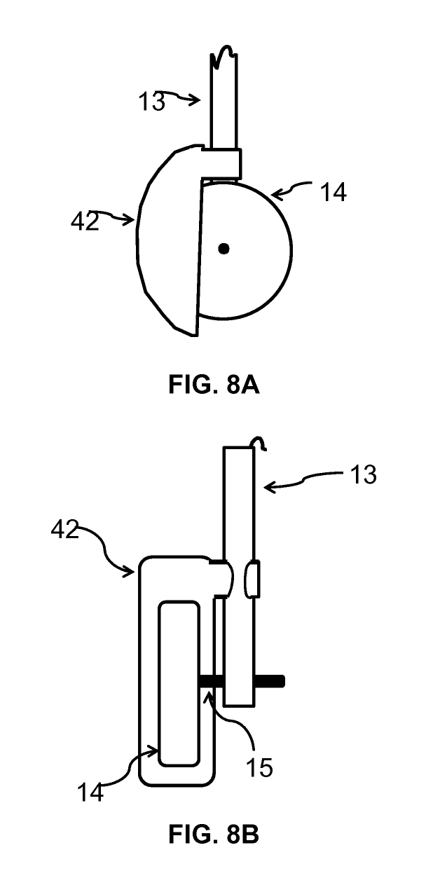

FIG. 8A shows snap-on wheel shield 42 attached to frame upright 13 and over wheel 14. FIG. 8B illustrates how, in some embodiments, snap-on wheel shield 42 does not interfere with the connection between wheel 14 and axle 15.

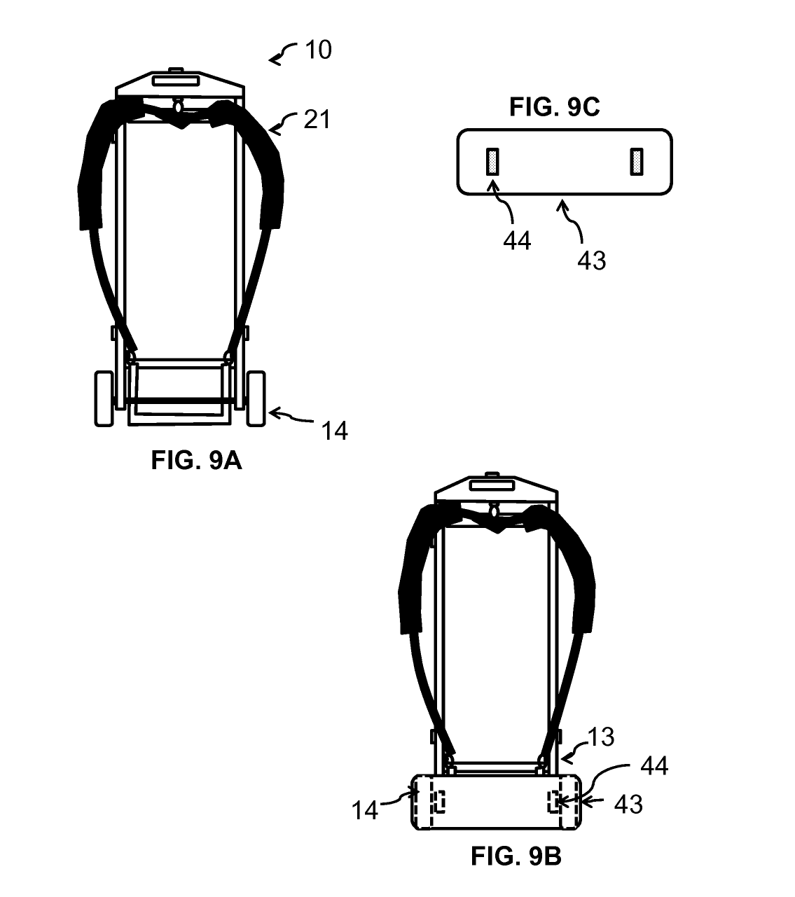

Turning to FIG. 9A, backpack-cart 10 is shown in backpack mode with harness strap 21 attached. FIG. 9B is the same as FIG. 9A with the addition of back support cushion pad with flared end shields 43 attached to frame upright 13 via back support attachment snaps 44 and positioned so that wheel 14 does not come in contact with the user.

FIG. 9C illustrates one embodiment of support cushion pad with flared end shields 43. It shows the location for back support attachment snaps 44 that snap over frame upright 13 (see FIG. 9B). In addition to helping reduce, if not eliminate, the contact between wheel 14 and a user's body, support cushion pad 43 can help alleviate the stress on the user's back.

While particular elements, embodiments and applications of the present invention have been shown and described, it will be understood, that the invention is not limited thereto since modifications can be made without departing from the scope of the present disclosure, particularly in light of the foregoing teachings.

What is claimed is:

1. A wheel cover comprising:
(a) a wheel cover configured to encase a wheel on a backpack-cart; and
(b) an attachment mechanism capable of attaching said wheel cover to said wheel.

2. The wheel cover of claim 1, wherein said attachment mechanism is an elastic band.

3. The wheel cover of claim 1, wherein said attachment mechanism is a drawstring.

4. The wheel cover of claim 1, wherein said attachment mechanism is a strap comprising a cooperating hook and loop fastening material.

5. The wheel cover of claim 1, wherein said attachment mechanism is a button.

6. The wheel cover of claim 1, wherein said attachment mechanism is a zipper.

7. The wheel cover of claim 1, wherein said attachment mechanism is a runner formed of a cooperating hook and loop fastening material capable of circumscribing said wheel.

8. The wheel cover of claim 1, wherein said attachment mechanism has a partial clam shell conformation.

9. The wheel cover of claim 1, wherein said wheel cover is water resistant.

10. A wheel shield comprising a surface configured to reduce contact between a wheel of a backpack-cart and a user when said backpack-cart is employed by said user as a backpack.

11. The wheel shield of claim 10, wherein said surface is a back support pad.

12. The wheel shield of claim 11, wherein said back support pad is cushioned.

13. The wheel shield of claim 11, wherein said back support pad is configured to attach to an upright frame of said backpack-cart with a back support strap.

14. The wheel shield of claim 11, wherein said back support pad has flared edges.

15. The wheel shield of claim 10, wherein said surface is configured to attach to an upright frame portion of said backpack-cart.

16. The wheel shield of claim 10, wherein said surface is a harness waist belt.

17. The wheel shield of claim 16, wherein said harness waist belt is part of a full pack harness.

18. A backpack-cart assembly comprising:
(a) a back-pack cart; and
(b) a wheel cover, wherein said wheel cover is configured to encase a wheel of said back-pack cart.

19. The backpack-cart assembly of claim 18 further comprising:
(c) an attachment mechanism capable of attaching said wheel cover to said wheel.

20. The backpack-cart assembly of claim 19 wherein said attachment mechanism is a pair of magnets.
